(19) United States
(12) Patent Application Publication
(10) Pub. No.: US 2003/0225788 A1
(43) Pub. Date: Dec. 4, 2003

(54) Container management method and container management system

(76) Inventors: Ikuo Kawakami, Tokyo (JP); Nobobru Watanabe, Tokyo (JP); Takeshi Nishikido, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/400,914

(22) Filed: Mar. 28, 2003

(30) Foreign Application Priority Data
Apr. 17, 2002 (JP) 2002-114885

(51) Int. Cl. G06F 17/00

(52) U.S. Cl. 707/104.1

(57) ABSTRACT

To provide a container management method and container management system for avoiding a complicated procedure required when using returnable containers.

A system according to the present invention includes an export database 1, an export data management device 2, an import database 5, an import data management device 6, a container database 3, a container data management device 4, and a packaging data management device 7. The export data management device sends container shipment results including an invoice number, a container symbol, and quantity of containers to the container data management device. The import data management device sends container return results including a container symbol and quantity of containers to the container data management device. The container data management device stores the invoice number, the container symbol, and the quantity of the shipped containers as data for those having been shipped, in the container database, and stores the container symbol and the quantity of the returned containers as data for those having been returned, in the container database.

### BACKGROUND OF THE INVENTION

1. Field of the Invention

The present invention relates to a management method and management system for containers returned to a shipping site out of containers containing merchandise therein shipped from the shipping site, that is returnable containers. Here, the merchandise includes any things to be distributed, and products and parts of the products.

2. Background of the Invention

Here, it is assumed that, for example parts of a vehicle are shipped. The parts packaged in cardboards are further contained in containers to be loaded in a shipping container. The containers have two types. One type is a so-called returnable container which, after the parts are taken out at a destination, is small folded to be returned to the shipping site. The other type is a container which, after the parts are taken out at the destination, is discarded.

Conventionally, the returnable containers have been used only in the case of domestic distribution of merchandise. This is mainly because it is difficult to collect the containers from a large number of destinations overseas. However, in recent years, there is employed a system where a small number of hubs are provided overseas and the parts are distributed from the hubs to peripheral areas. Therefore, it is no longer difficult to collect the returnable containers from overseas.

However, there is further a problem of custom formality in order to collect the returnable containers from the destinations overseas. Even the containers are required the custom formality both at export and at import each and every time. It is necessary to meet the following requirements in order to be applied the rules of exemption from customs duty (11th paragraph of article 14 of the customs tariff law) as the returnable containers. First, a ledger on the shipment and return has to be kept. Therefore, it is necessary to create a ledger on the shipment and return of the returnable containers. But a constant reporting obligation is not required, the company itself has only to hold it over a predetermined period of time (seven years). Second, it is necessary to be able to confirm that the re-imported containers are the same as the exported containers. Therefore, a labeling of the origin and a clear indication of the owner on the returnable containers are required. An individual name is required for the returnable containers, and it is necessary to hand in the report to the regulatory agency. Third, the type and the quantity of returnable containers have to be described on the export report handed in to the regulatory agency. Therefore, it is necessary to describe the type and the quantity of returnable containers to be used in the export report in addition to the invoice specification.

As described above, a complicated procedure is required in order to use the returnable containers with respect to the destinations overseas. Therefore, conventionally, a large amount of man-hours have been required or a large-scaled system has been required to construct in order to perform such a procedure.

The documents disclosing the prior art on a returnable container (carrier box) include Japanese Patent Application Laid-Open Nos. 11-120250, 2001-261120, and 2001-341845, and the like.

However, the above documents do not disclose a container management method and container management system for using returnable containers with respect to the destinations overseas.

### SUMMARY OF THE INVENTION

So, there is a need to provide a container management method and container management system for performing a procedure required when using returnable containers with respect to destinations overseas.

The container management method according to the present invention is performed by a system comprising an export database, an import database, and a container database. The export database stores an invoice number of merchandise to be shipped, a packaging number, a container symbol for identifying the container type of the merchandise, and quantity of containers therein in an associated manner. The import database stores a container symbol and quantity of containers returned from the destinations therein. The container database functions in cooperation with the export database and the import database, and stores shipment and return states of containers and quantity of containers per container symbol. The container management method according to the present invention comprises the steps of storing a packaging number, a container symbol and quantity of containers in the export database in association with an invoice number, and storing a container symbol of shipped containers, quantity of containers, and an export license number as data for those having been shipped in the container database on the basis of the data in the export database. The container management method according to the present invention further comprises the steps of storing a container symbol and quantity of containers returned from the destinations in the import database, and storing the container symbol and the quantity of returned containers as data for those having been returned in the container database on the basis of the data in the import database.

The container management system according to the present invention comprises an export database, an export data management device, an import database, an import data management device, a container database, a container data management device, and a packaging data management device. The export database stores an invoice number of merchandise to be shipped, a packaging number, a container symbol for identifying a container type of merchandise, and quantity of containers therein in an associated manner. The export data management device manages the export database. The import database stores a container symbol and quantity of containers returned from the destinations therein. The import data management device manages the import database. The container database functions in cooperation with the export database and the import database, and stores shipment and return states of containers and quantity of containers therein for each container symbol. The container data management device manages the container database. When packaging merchandise in the containers, the packaging data management device sends the packaging number and the container symbol to the export data management device. Further, the export data management device sends container shipment results including the invoice number, the container symbol, and the quantity of containers to the container data management device on the basis of the data in the export database. The import data management device receives a container symbol and quantity of the containers returned from the destinations, and sends container return results including the container symbol and the quantity of containers to the container data management device. The container data management device stores the invoice number, the container symbol, and the quantity of the shipped containers as data for those having been shipped, in the container database on the basis of the data in the export database, and stores the container symbol and the quantity of the returned containers as data for those having been returned, in the container database on the basis of the data in the import database.

According to the present invention, quantity of shipped containers and quantity of returned containers can be managed for each container type in association with the container shipment (export) and return (import) processings.

According to a preferred embodiment of the present invention, the system further comprises a container master for storing container characteristics therein in association with container symbol. Therefore, it is possible to grasp the container characteristics for each container type.

According to a preferred embodiment of the present invention, the export data management device creates data for an export report including a container symbol, container characteristics, and quantity of containers for each invoice number on the basis of the data in the export database and the container master. So, it has been made possible to create the export report including the container symbol, the container characteristics, and the quantity of containers for each invoice number.

According to a preferred embodiment of the present invention, the container database further stores an export licensed date and an export license number therein. Therefore, quantity of exported returnable containers can be accurately managed in association with an export license number and an export licensed date.

According to a preferred embodiment of the present invention, when storing the container symbol and the quantity of returned containers as data for those having been returned in the container database, the container database management device regards, as having been returned, a certain number of containers having the same container symbol with the returned containers and having earlier export licensed dates in the data of the container database, the certain number being the number of the returned containers. Therefore, it has been made possible to accurately manage states and quantity of containers for each container type without tracking individual returnable containers.

### BRIEF DESCRIPTION OF THE DRAWINGS

FIG. 1 is a diagram showing a configuration of a first embodiment of a container management system according to the present invention;

FIG. 2 is a flow chart showing a processing other than container export (shipment) and import (return) of a container management method according to the present invention;

FIG. 3 is a flow chart showing a processing of export (shipment) of the container management method according to the present invention;

FIG. 4 is a flow chart showing a processing of import (return) of the container management method according to the present invention;

FIG. 5 is a flow chart showing details of step S430 in FIG. 4;

FIG. 6 is a view showing one example of a configuration of a container master;

FIG. 7 is a view showing a configuration of an export database;

FIG. 8 is a view showing one example of a configuration of a container database;

FIG. 9 is a table showing one example of change in quantities of shipped containers and returned containers;

FIG. 10 shows a data processing when quantities of shipped containers and returned containers change;

FIG. 11 is a view showing one example of an export/import management ledger format;

FIG. 12 is a flow chart showing the entire processing of the container management system according to the present invention;

FIG. 13 is a view showing one example of a master registration screen for use in container master registration;

FIG. 14 is a view showing one example of a container purchasing/discarding screen;

FIG. 15 is a view showing one example of a container import registration screen;

FIG. 16 is a view showing one example of an import license form number registration screen; and

FIG. 17 is a view showing a configuration of an export report.

### PREFERRED EMBODIMENTS OF THE INVENTION

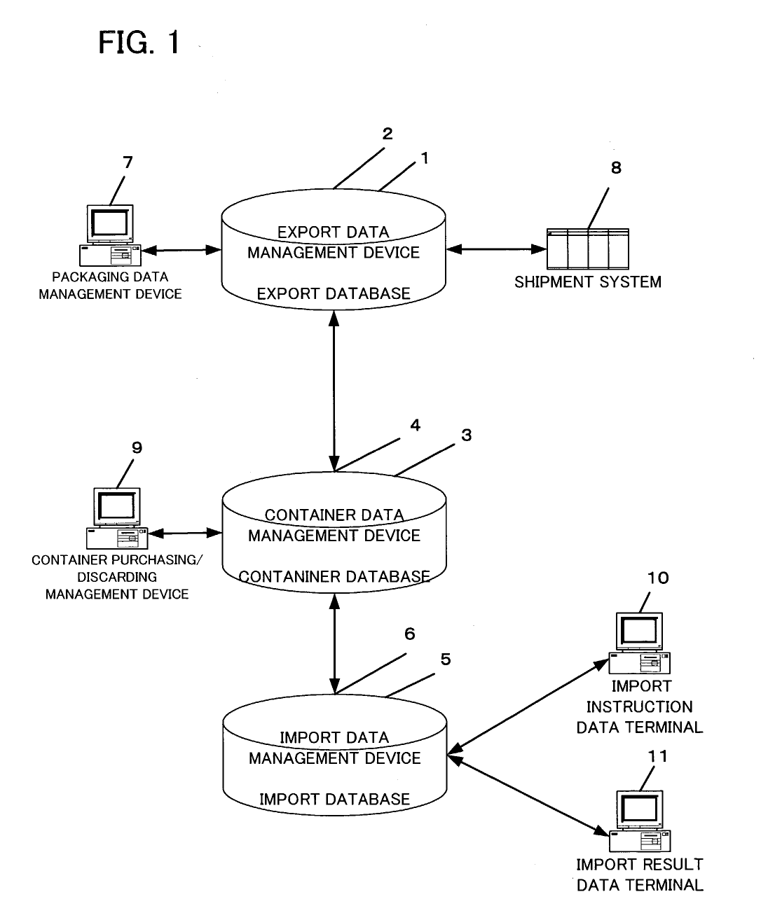

FIG. 1 schematically shows a configuration of a first embodiment of a container management system according to the present invention. The container management system according to the present invention comprises an export database 1, a container database 3, and an import database 5. Further, the databases are provided with an export data management device 2, a container data management device 4, and an import data management device 6, respectively. In FIG. 1, the export data management device 2, the container data management device 4, and the import data management device 6 are integrated with the export database 1, the container database 3, and the import database 5, respectively. The export database 1 and the container database 3 are connected via the export data management device 2 and the container data management device 4. Further, the container database 3 and the import database 5 are connected via the container database management device 4 and the import data management device 6.

The container management system according to the present invention also includes a packaging data management device 7 connected to the export database 1 via the export data management device 2. Further, the container management system according to the present invention may comprise a container purchasing/discarding management device 9 connected to the container database via the container data management device 4. Alternatively the container data management device 4 may perform functions of the container purchasing/discarding management device 9. The container management system according to the present invention is also connected to a shipment system 8 via the export data management device 2. The shipment system 8 performs processing on shipment (lading). Furthermore, the container management system according to the present invention may include an import instruction data terminal 10 and an import result data terminal 11 which are connected to the import database 5 via the import data management device 6.

The export data management device 2, the container data management device 4, the import data management device 6, the packaging data management device 7, the shipment system 8, the container purchasing/discarding device 9, the import instruction data terminal 10, and the import result data terminal 11 may each include a processor and a memory, and may be realized by computers such as one or a plurality of personal computers, work stations, mainframes, and the like managed by predetermined operating systems. When they are realized by a plurality of computers, the plurality of computers can be connected to one another through a network such as a local area network or a wide area network.

The export database 1, the container database 3, and the import database 5 can be realized using memories of the above computers. They may be realized by either individual memories or the same memory. A general-purpose database software may be installed in the above computers.

The export database 1 stores an invoice number of merchandise to be shipped, a packaging number, a container symbol for identifying a container type of merchandise, and quantity of containers therein in an associated manner. The import database 5 stores the container symbol and the quantity of containers returned from destinations therein. The container database 3 functions in cooperation with the export database and the import database, and stores shipment and return states and quantity of containers for each container symbol and each invoice number. The configurations of these databases will be described below in detail.

The export data management device 2 sends shipment instruction data including an invoice number, a container symbol and quantity of containers to the shipment system 8 on the basis of the data in the export database 1, and sends container shipment results including the invoice number, the container symbol, and the quantity of containers to the container data management device 4.

The import data management device 6 receives a container symbol and quantity of containers returned from the destinations, and sends the container return results including the container symbol and the quantity of containers to the container data management device. The data including the container symbol and the quantity of containers returned may be received via the import instruction data terminal 10 and the import result data terminal 11.

The container data management device 4 stores an invoice number, a container symbol, quantity of containers, and an export license number of shipped containers as those having been shipped, in the container database 3 on the basis of the data in the export database 1, and stores a container symbol and quantity of the returned containers as those having been returned, in the container database on the basis of the data in the import database 5. In such a manner, according to the system of the present invention, the shipment and return states of containers can be grasped for each container type.

The packaging data management device 7 sends the packaging number, the container symbol, and the quantity of containers to the export data management device when packaging merchandise in the containers. The data such as the container symbol regarding the containers is tied to the packaging number by the packaging data management device 7.

The container purchasing/discarding management device 9 is used for inputting container characteristics or inputting container purchasing/discarding results.

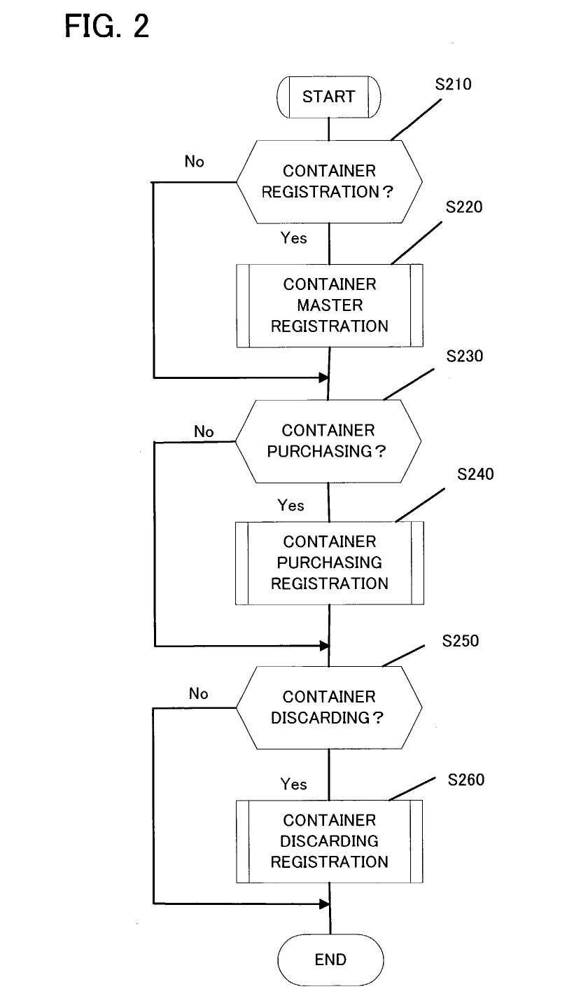

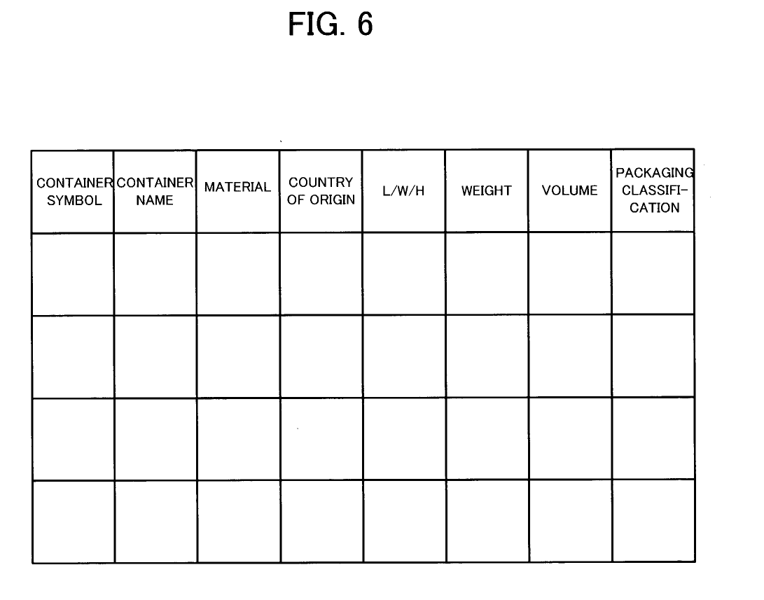

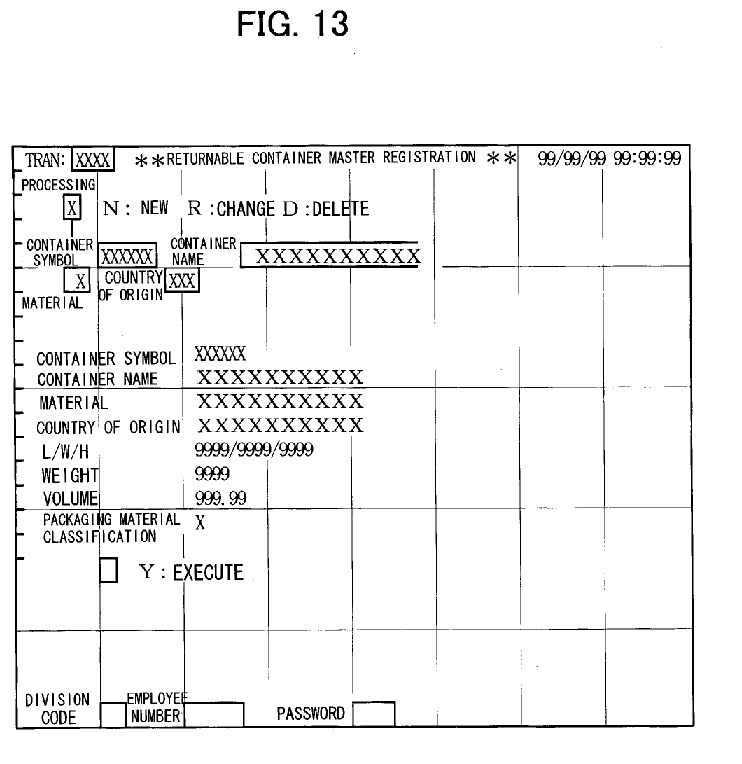

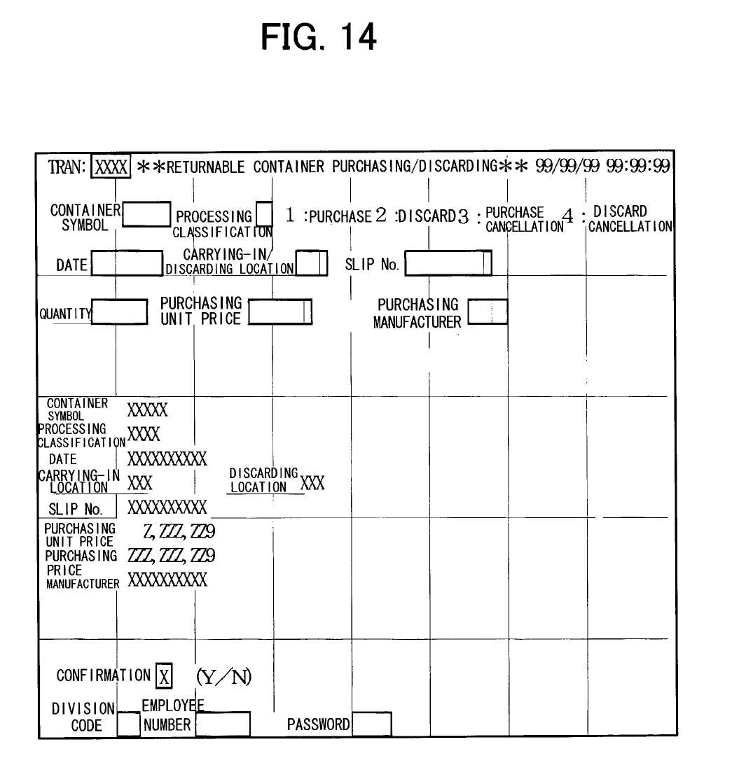

Next, a container management method according to the present invention will be described on the basis of the flow charts. FIG. 2 shows a processing other than export (shipment) and import (return) of containers. The processing in FIG. 2 is performed mainly by the container purchasing/discarding management device 9. In step S210 in FIG. 2, it is determined whether or not a container is to be newly registered. In the case of the new container registration, in step S220, the container symbol and the container characteristics for uniquely identifying the container type are registered in the container master. The container master may be configured on the same storage device as the container database 3 or on a separate storage device. One example of a configuration of the container master is shown in FIG. 6. Name, material, country of origin, L/W/H (length/width/height), weight, volume (dimensions by cubic feet unit), packaging classification, and the like are registered as the container characteristics. FIG. 13 shows one example of a master registration screen for use in a container master registration. Next, in step S230 in FIG. 2, it is determined whether or not a container purchasing is to be registered. In the case of the container purchasing registration, in step S240, the quantity of containers having the same container symbol as the purchased containers, which is stored in the container database 3, is increased by the quantity of purchased containers. Then, in step S250 in FIG. 2, it is determined whether or not a container discarding is to be registered. In the case of the container discarding registration, in step S260, the quantity of containers having the same container symbol as the discarded containers, which is stored in the container database 3, is decreased by the quantity of discarded containers. FIG. 14 shows one example of a container purchasing/discarding screen.

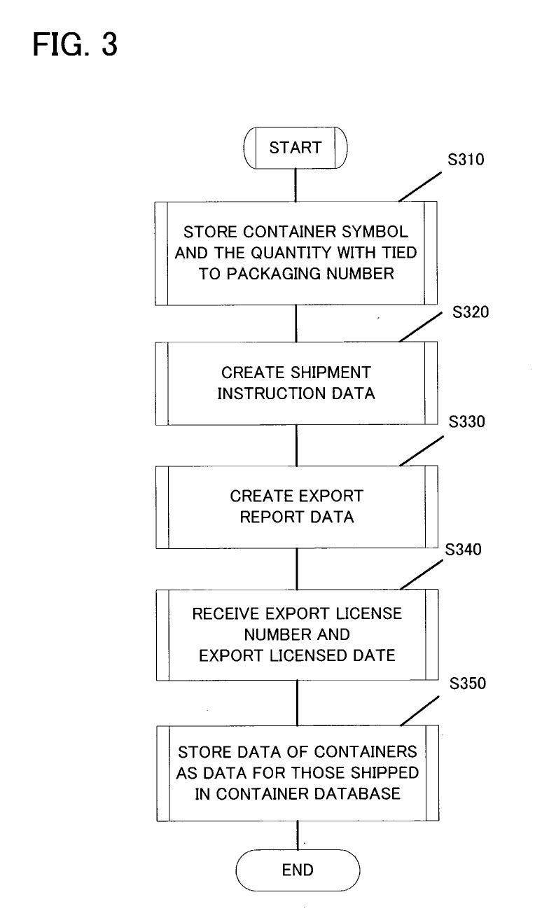

FIG. 3 shows a processing of export (shipment) of the container management method according to the present invention. In step S310 in FIG. 3, when packaging merchandise in the containers, the packaging data management device 7 sends the packaging number, the container symbol, and the quantity of containers to the export data management device 2 in an associated manner. Specifically, the packaging number, the container symbol, and the quantity of containers may be manually input into the screen of the packaging data management device 7. Alternatively, either one or both a machine readable code such as a barcode on a packaging tag and a machine readable code such as a barcode attached on a container may be read by the packaging data management device 7 so as to be associated with each other. On the other hand, the export database 1 stores the data including an invoice number and a packaging number of merchandise to be exported therein in advance. In other words, processings such as packaging, shipment, and the like are performed on the basis of the data stored in the export database. Therefore, when a packaging number, a container symbol, and quantity of containers are received from the packaging data management device 7, these can be further stored in association with an invoice number. The important point to note is that a container symbol and quantity of containers are associated with a packaging number and further are associated with an invoice number, by the above processing.

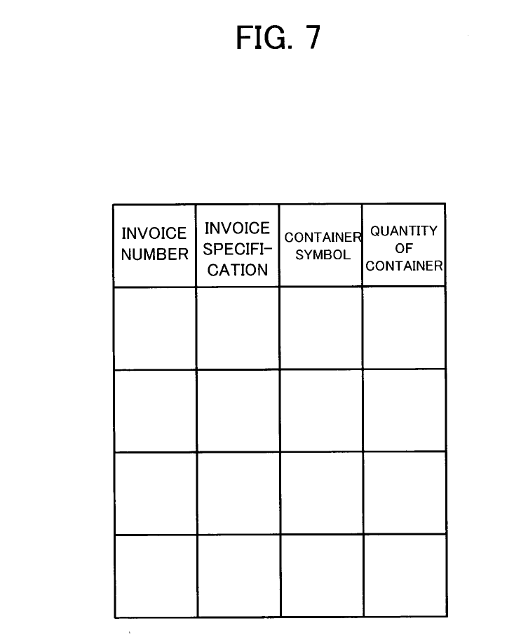

FIG. 7 shows a configuration of the export database. An invoice specification including a packaging number, a container symbol, and the quantity of containers are stored in association with an invoice number.

In step S320 in FIG. 3, the export data management device 2 creates shipment instruction data on the basis of the export database 1. The shipment instruction data includes an invoice number, an invoice specification, a packaging number, a container symbol, and the quantity of containers. The export data management device 2 sends the created shipment instruction data to the shipment system 8. In addition, the shipment instruction data may be created by another device which functions in cooperation with the export data management device 2. The important point to note is that a container symbol and quantity of containers are associated with an invoice number, an invoice specification, and a packaging number by the export data management device 2 in the shipment instruction.

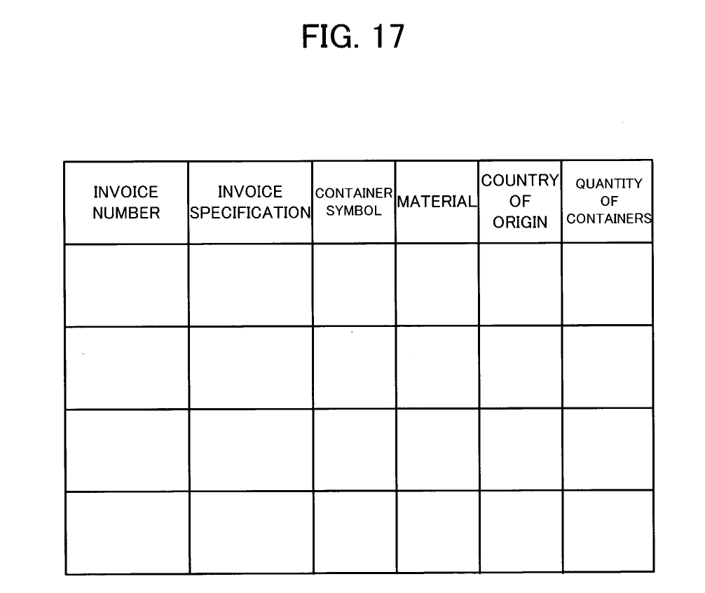

In step S330 in FIG. 3. the export data management device 2 creates the data for the export report on the basis of the export database 1 and the container master. FIG. 17 shows a configuration of the export report. A container symbol, quantity of containers, a material of containers, and a country of origin of containers are described in addition to an invoice number and an invoice specification. The export data management device 2 associates the above respective items of data in cooperation with the export database 1 and the container master. In fact, the export report may be created by the shipment system or another system in cooperation with the shipment system on the basis of the data created by the export data management device 2. The export declaration of returnable containers can be performed by the export report including the container data.

In step S340 in FIG. 3, the export data management device 2 receives data such as an export license number and an export licensed date from the shipment system 8. At this time, the export data management device 2 sends data such as the invoice number, the container symbol, the quantity of containers, and the like relating to the export license number, which are stored in the export database 1, as data for those having been exported, to the container data management device.

In step S350 in FIG. 3, the container data management device 4 stores the above data received from the export data management device 2 as data for those having been shipped (exported), in the container database 3.

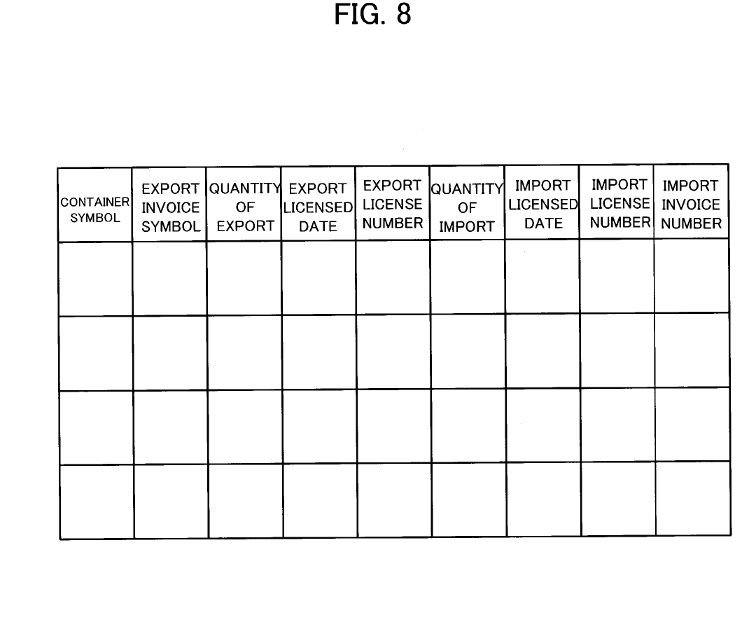

FIG. 8 shows one example of a configuration of the container database. The container database includes a container symbol, an export invoice number, quantity of exported containers, an export licensed date, an export license number, quantity of imported containers, an import licensed date, an import license number, and an import invoice number. The data about the export is stored in the processing in the above step S350. The data about the import will be described later.

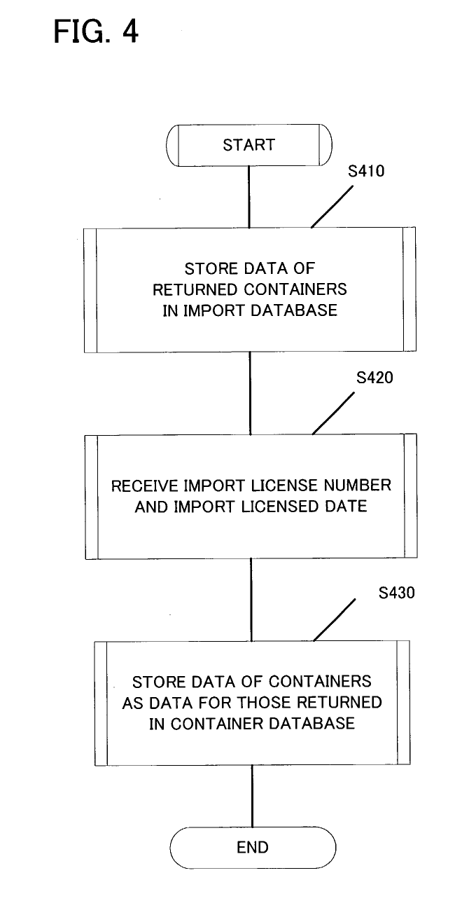

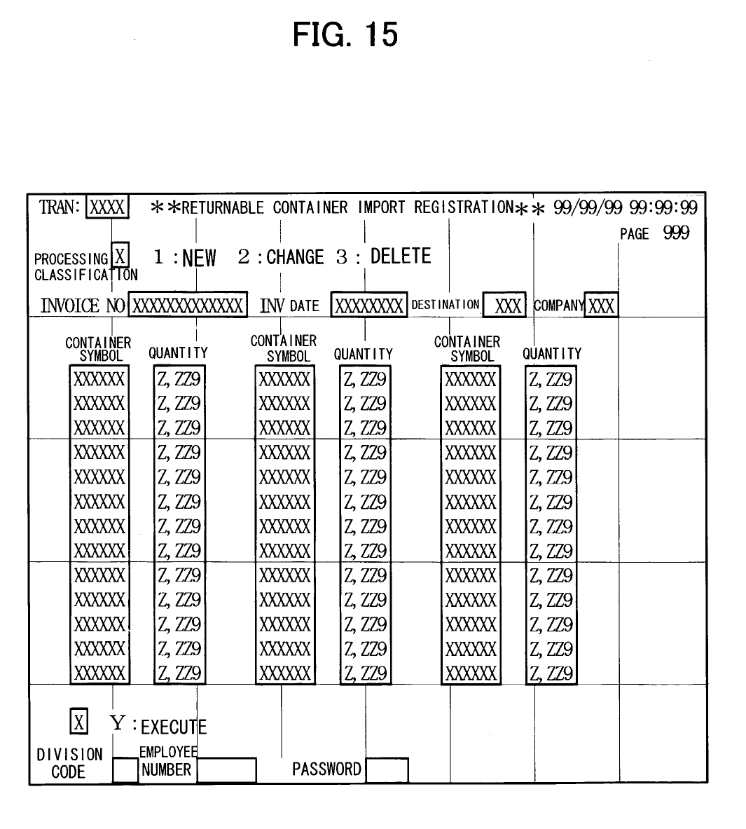

FIG. 4 shows a processing of import (return) of the container management method according to the present invention. In step S410 in FIG. 4, the import data management device 6 stores the data about the returned containers in the import database 5. The configuration of the import database is identical to the configuration of an export database in FIG. 7. The import data management device 6 may receive the data about the returned containers, for example, via a dedicated line from the system at the destination. The data about the returned containers includes a container symbol, quantity of containers, and an import invoice number. Alternatively, the data including a container symbol, quantity of containers, and an import invoice number may be input from a terminal of the import data management device 6. One example of a container import registration screen therefor is shown in FIG. 15.

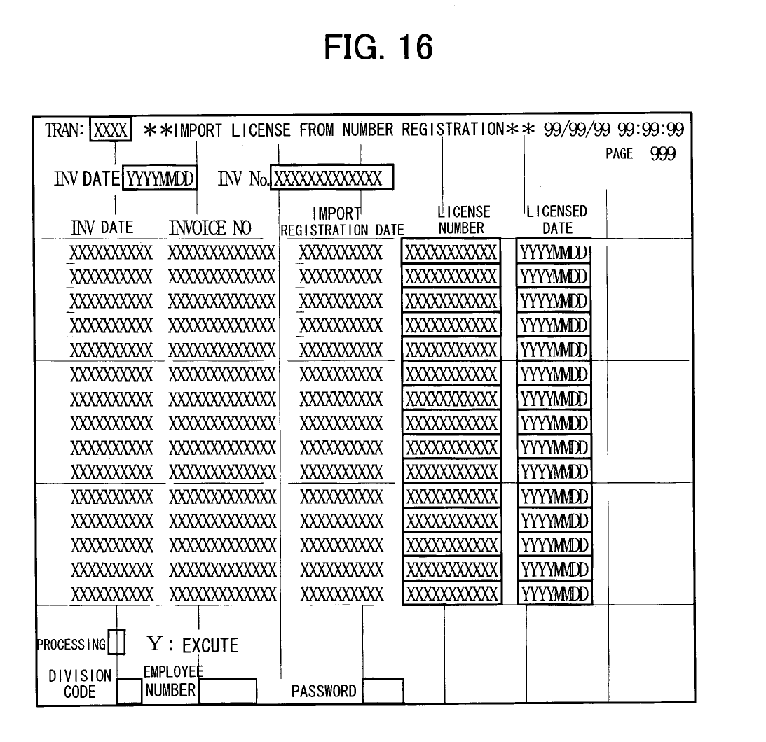

Next, in step S420 in FIG. 4, the import data management device 6 receives data including an import licensed date, an import license number, and an import invoice number from the shipment system 8 via the dedicated line or the like. Alternatively, the data including an import licensed date, an import license number, and an import invoice number may be input from a terminal of the import data management device 6. One example of an import license form number registration screen therefor is shown in FIG. 16.

In step S430 in FIG. 4, the container data management device 4 stores the above data received from the import data management device 6 as data for those having been returned (imported), in the container database 3.

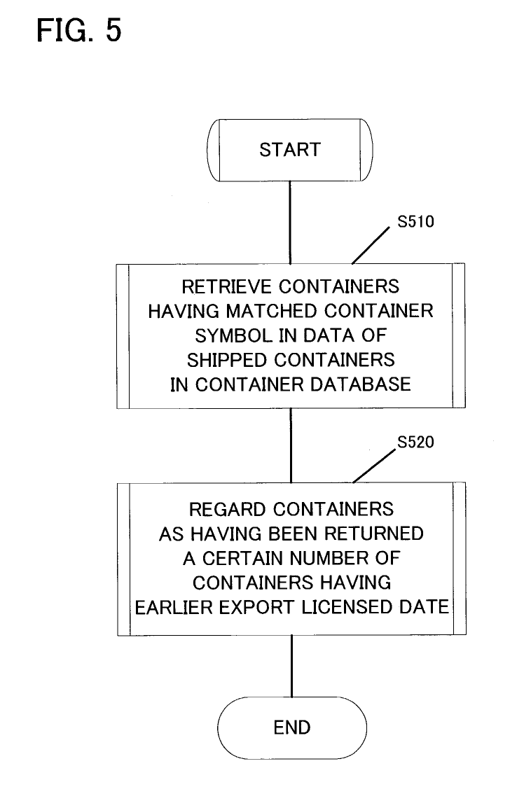

FIG. 5 shows details of step S430 in FIG. 4. In step S510 in FIG. 5, the container data management device 4 retrieves the data having the same container symbol as the container symbol of the data received from the import data management device 6 out of the data in the container database 3. The quantity of shipped containers having the same container symbol must be certainly more than the quantity of containers to be returned. This is because the containers to be returned are part of the shipped containers.

In step S520 in FIG. 5, the container data management device 4 regards, as having been returned, a certain number of containers having the same container symbol with the received data and having earlier export licensed dates in the data of the container database 3. The certain number is that of the retuned containers.

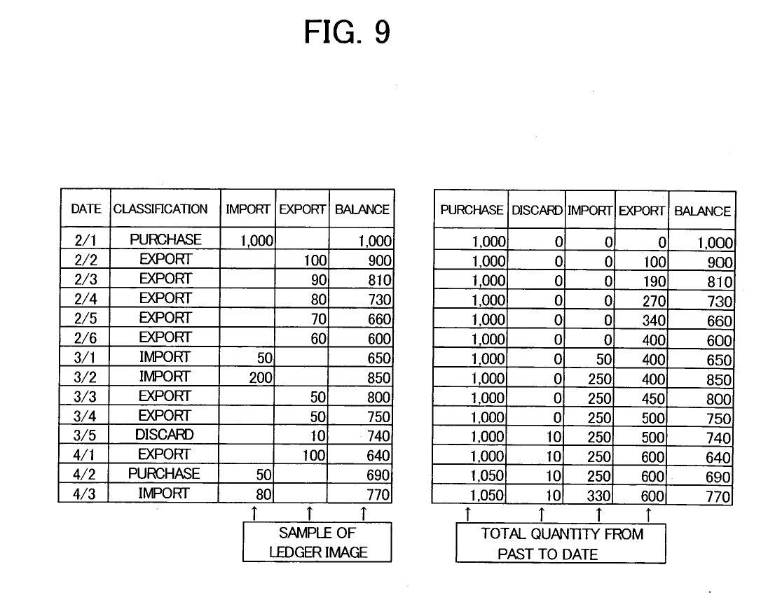

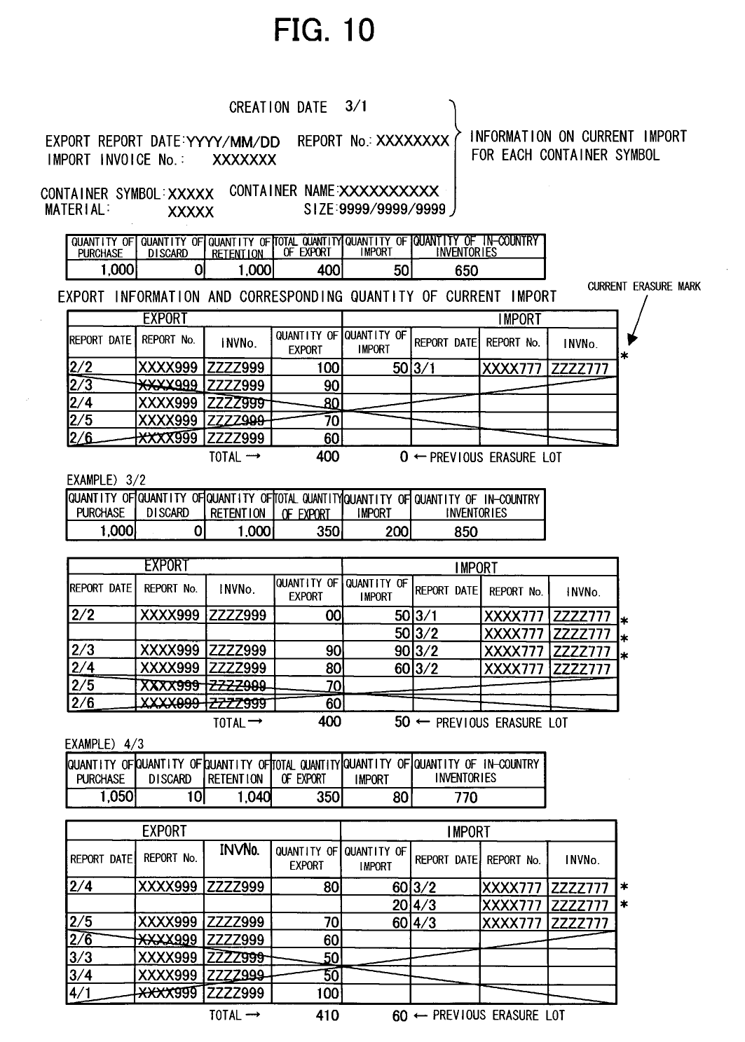

A processing in step S520 in FIG. 5 will be described in detail with reference to FIGS. 9 and 10. FIG. 9 is a table showing one example of a change in quantities of the shipped containers and returned containers. Import, export, purchasing, and discarding change quantity of containers. “Balance” means quantity obtained by subtracting a sum of quantity of exported containers and discarded containers from a sum of quantity of purchased containers and imported containers, that is the quantity of containers at the shipping site.

FIG. 10 shows a data processing when quantities of shipped containers and returned containers change as shown in FIG. 9. The portions indicated with X are the portions which are stored as data but do not relate to the processing. In FIG. 10, it is assumed that 50 containers are returned on March 1st. The total number (the quantity obtained by subtracting the accumulated number of imported containers from the accumulated number of exported containers) of exported containers before the return is 400. In the container database 3, on February 2nd that is the earliest export licensed date (report date), the quantity of exported containers is 100. Therefore, 50 containers thereof are regarded as having been returned and the remaining 50 containers are regarded as having not been returned. As a result, the total number of exported containers is reduced to 350 that is less than 400 by 50. Next, it is assumed that 200 containers are returned on March 2nd. In the container database 3, the remaining 50 containers out of 100 containers are shipped on February 1st that is the earliest export licensed date (report date). The 50 containers thereof are regarded as having been returned, and further 90 containers shipped on February 3rd and 60 containers out of 80 containers shipped on February 4th are regarded as having been returned. Remaining 20 containers out of the 80 containers shipped on February 4th are regarded as having not been returned. As a result, the balance after erasure is 350−200=150. Further, it is assumed that, after 200 containers are exported, 80 containers are returned on April 3rd. In the container database 3, the earliest export licensed date (report date) is February 4th on which the 80 containers including the remaining 20 containers are shipped. The 20 containers are regarded as having been returned, and further 60 containers out of 70 containers shipped on February 5th are regarded as having been returned. 10 containers out of the 70 containers shipped on February 5th are regarded as having not been returned.

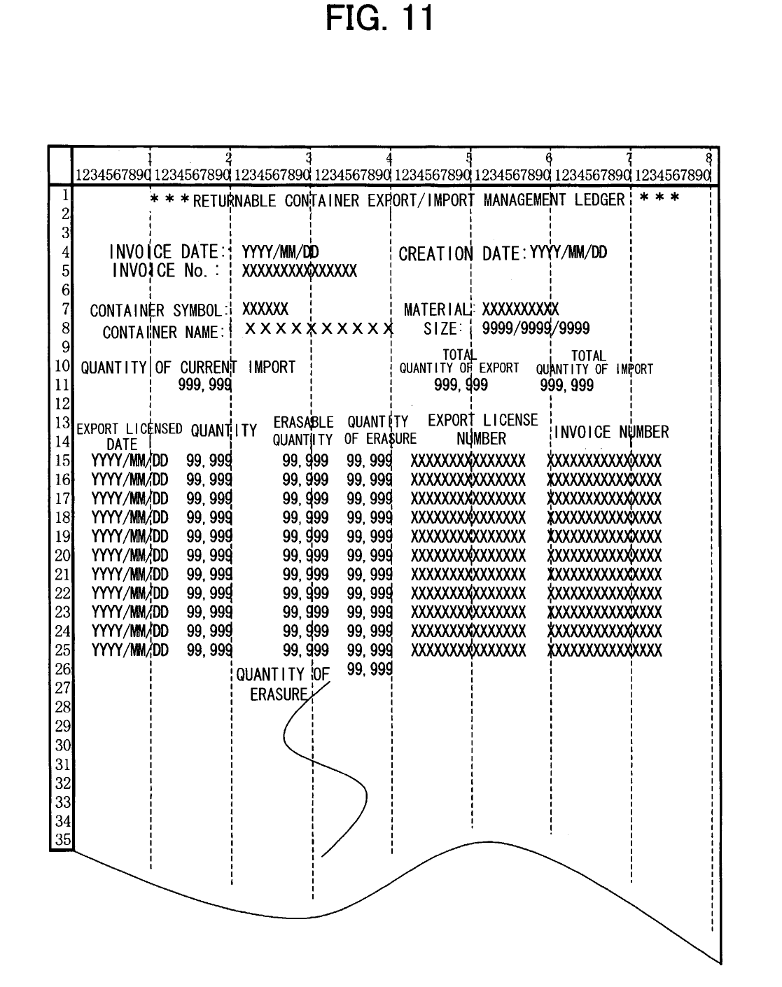

FIG. 11 is a view showing one example of an export/import management ledger format created by the processing described using FIG. 10. In FIG. 11, “erasure” means allocation of the return for the shipped containers as described with reference to FIGS. 9 and 10.

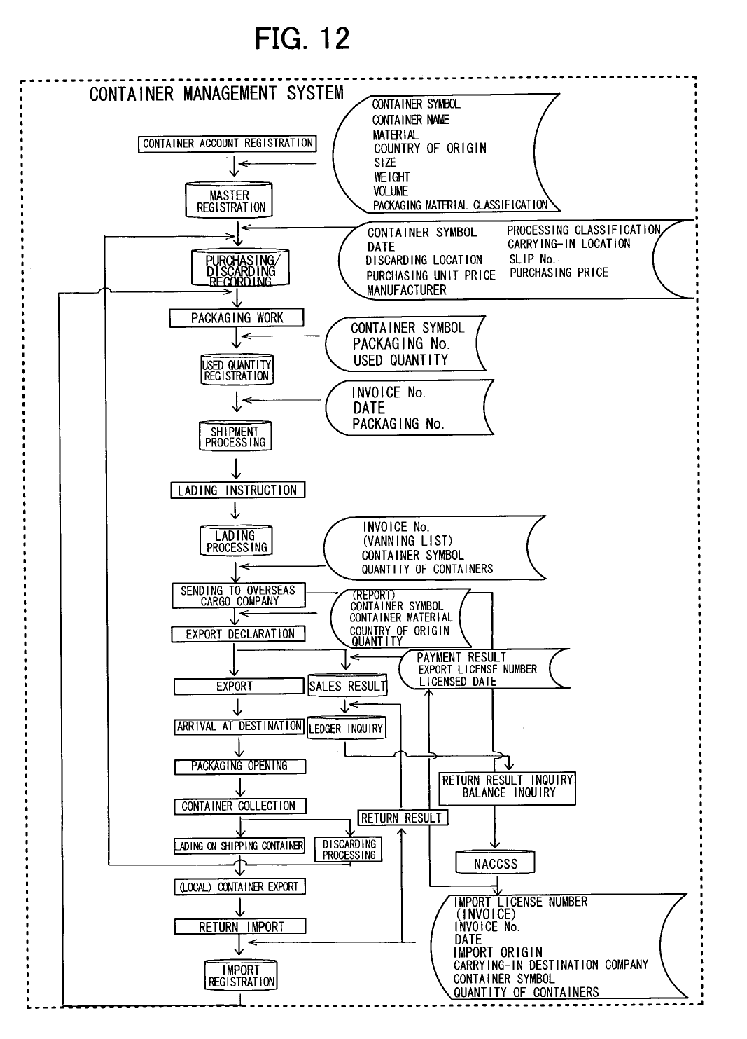

FIG. 12 is a flow chart showing the entire processing regarding the container management system according to the present invention described above. In the drawing, the processing from “export declaration” to “(local) container export” is performed outside the container management system. The container management system provides the required data such as the export report data to the outside, and receives the data such as an export license number, an export licensed date, an import license number, an import licensed date, and the like from the outside. NACCSS (Nippon Automated Cargo Clearance System) indicates a cargo clearance system. The system according to the present invention and the outside system may exchange the data via an overseas cargo company.

According to the present invention, quantity of shipped containers and quantity of returned containers can be managed in association with an invoice number and a packaging number for each container type. Therefore, the management of the returnable containers can be performed in association with the shipment (export) processing.

According to a preferred embodiment of the present invention, further, the container characteristics can be grasped for each container type.

According to a preferred embodiment of the present invention, an export report including the container symbol, container characteristics, and quantity of containers can be created for each invoice number. Therefore, load of the complicated export declaration procedure for returnable containers can be alleviated.

According to a preferred embodiment of the present invention, the quantity of exported returnable containers can be accurately managed in association with the export license number and the export licensed date.

According to a preferred embodiment of the present invention, states and quantity of containers can be accurately managed for each container type without tracking individual returnable containers. Therefore, the management of the containers can be performed by the simple method and system without introducing equipment or man-hours for tracking returnable containers.

What is claimed is:

1. A container management method for managing containers returned after shipment by a system including:
an export database for storing an invoice number of merchandise to be shipped, a packaging number, a container symbol for identifying a container type of the merchandise, and quantity of containers therein in an associated manner;
an import database for storing a container symbol and the quantity of containers returned from destinations, therein; and
a container database functioning in cooperation with the export database and the import database, for storing shipment and return states and quantity of containers for each container symbol,
the container management method comprising the steps of:
storing a packaging number, a container symbol, and quantity of containers in the export database in association with an invoice number;
storing an invoice number, a container symbol, and quantity of shipped containers as data for those having been shipped, in the container database on the basis of the data in the export database;
storing a container symbol and quantity of containers returned from destinations in the import database; and
storing a container symbol and quantity of returned containers as data for those having been returned, in the container database on the basis of the data in the import database.

2. A container management method according to claim 1, wherein the system further comprises a container master for storing container characteristics therein in association with a container symbol.

3. A container management method according to claim 2, further comprising the step of, after the step of storing in the export management database, creating data for an export report including a container symbol, container characteristics, and quantity of containers for each invoice number on the basis of the data in the export database and the container master.

4. A container management method according to any one of claims 1 to 3, wherein the container database further stores an export licensed date and an export license number therein.

5. A container management method according to claim 4, wherein in the step of storing a container symbol and quantity of returned containers as data for those having been returned in the container database, a certain number of containers having the same container symbol with the returned containers and having earlier export licensed dates in the data of the container database, are regarded as having been returned, the certain number being the number of the returned containers.

6. A system for managing containers returned after shipment, comprising:
an export database for storing an invoice number of merchandise to be shipped, a packaging number, a container symbol for identifying a container type of the merchandise, and quantity of containers therein in an associated manner;
an export data management device for managing the export database;
an import database for storing a container symbol and quantity of containers returned from destinations therein;
an import data management device for managing the import database;
a container database functioning in cooperation with the export database and the import database, for storing shipment and return states and quantity of containers for each container symbol and each invoice number therein;
a container data management device for managing the container database; and
a packaging data management device for sending a packaging number and a container symbol to the export data management device when packaging a merchandise in containers,
wherein the export data management device sends container shipment results including an invoice number, a container symbol, and quantity of containers to the container data management device on the basis of the data in the export database,
the import data management device receives a container symbol and quantity of containers returned from destinations, and sends container return results including the container symbol and the quantity of containers to the container data management device, and
the container data management device stores the invoice number, the container symbol, and the quantity of shipped containers as data for those having been shipped in the container database on the basis of the data in the export database, and stores the container symbol and the quantity of returned containers as data for those having been returned in the container database on the basis of the data in the import database.

7. A container management system according to claim 6, wherein the system further comprises a container master for storing container characteristics therein in association with a container symbol.

8. A container management system according to claim 7, wherein the export data management device creates data for an export report including a container symbol, container characteristics, and quantity of containers for each invoice number on the basis of the data in the export database and the container master.

9. A container management system according to any one of claims 6 to 8, wherein the container database further stores an export licensed date and an export license number therein.

10. A container management system according to claim 9, wherein when storing the container symbol and the quantity of returned containers as data for those having been returned in the container database, the container database management device regards, as having been returned, a certain number of containers having the same container symbol with the returned containers and having earlier export licensed dates in the data of the container database, the certain number being the number of the returned containers.
